(19) United States
(12) Patent Application Publication
(10) Pub. No.: US 2024/0031267 A1
(43) Pub. Date: Jan. 25, 2024

(54) FLOW TRACING FOR HETEROGENEOUS NETWORKS

(71) Applicant: VMware, Inc., Palo Alto, CA (US)

(72) Inventors: Ran Gu, Beijing (CN); Wenfeng Liu, Beijing (CN); Donghai Han, Beijing (CN); Jianjun Shen, Redwood City, CA (US); Zhengsheng Zhou, Beijing (CN)

(21) Appl. No.: 17/898,344

(22) Filed: Aug. 29, 2022

(30) Foreign Application Priority Data
Jul. 25, 2022 (WO) PCT/CN2022/107636

(51) Int. Cl. H04L 43/10; H04L 43/062

(52) U.S. Cl. CPC H04L 43/10; H04L 43/062

(57) ABSTRACT

Some embodiments of the invention provide a method for performing data traffic monitoring for a system that includes a set of heterogeneous networks that includes at least an overlay first network layer that is built on top of an underlay second network layer. The method is performed at a federation controller for the system. The method directs (1) a first set of components in the overlay first network layer to perform a first trace operation to trace a packet exchanged between two machines and passing through network components defined in the overlay first network layer and underlay second network layer and (2) a second set of components in the underlay second network layer to perform a second trace operation to trace the packet. The method receives, from the first and second sets of components, first and second sets of trace data collected during the first and second trace operations. The collected trace data includes correlation data for correlating the first and second sets of data. The method uses the correlation data to correlate the first and second sets of trace data to generate a final trace report identifying a complete path traversed by the packet through the overlay first network layer and underlay second network layer.

### BACKGROUND

Today, networks and systems can include multiple different network infrastructures, such as multiple overlay networks built on top of each other and an underlying physical network. Different network layers may exhibit different network behaviors, and implement different methods to perform packet tracing operations. As a result, it becomes impossible for users and network administrators to perform packet tracing operations across the different network layers.

### BRIEF SUMMARY

Some embodiments of the invention provide a method for performing data traffic monitoring for a system that includes a set of heterogeneous networks that includes at least an overlay first network layer that is built on top of an underlay second network layer. The method is performed in some embodiments by a federation controller for the system. The method directs (1) a first set of components in the overlay first network layer to perform a first trace operation to trace a packet exchanged between two machines and passing through network components defined in the overlay first network layer and underlay second network layer, and (2) a second set of components in the underlay second network layer to perform a second trace operation to trace the packet. From the first and second sets of components, the method receives first and second sets of trace data that were collected during the first and second trace operations and that include correlation data for correlating the first and second sets of trace data. The method uses the correlation data to correlate the first and second sets of trace data to generate a final trace report identifying a complete path traversed by the packet through the overlay first network layer and underlay second network layer.

In some embodiments, the federation controller directs the first and second sets of components to perform the first and second trace operations by providing a first trace request to a first controller for the overlay first network and a second trace request to a second controller for the underlay second network. The first and second controllers then direct the first and second sets of components to perform the first and second trace operations to trace the packet based on the first and second trace requests, according to some embodiments. Prior to providing the first and second trace requests to the first and second controllers, the federation controller of some embodiments translates a trace request received from a network administrator (e.g., through a user interface (UI)) into first and second formats that are compatible with the overlay first and underlay second networks, respectively, such that the first trace request has the first format and the second trace request has the second format, in some embodiments.

The federation controller, in some embodiments, receives the first and second sets of trace data from the first and second sets of components through the first and second controllers for the overlay first and underlay second networks. In some embodiments, the first and second controllers collect trace data from the first and second sets of components as the first and second trace operations are performed, and provide the collected trace data to the federation controller as first and second sets of trace data. The correlation data, in some embodiments, is included with the first and second sets of trace data based on instructions included with the first and second trace requests from the federation controller. The correlation data of some embodiments includes a marker identifying the trace data as trace data associated with the first or second trace operations. Also, in some embodiments, only one of the sets of trace data for the packet includes the correlation data.

In some embodiments, the overlay first network layer is a container network and the underlay second network is a logical network built on top of a physical underlay third network that includes a third set of components. The first set of components of the container network includes a set of one or more containers, in some embodiments. The containers of some embodiments are implemented in pods, with each pod executing one or more containers. In some embodiments, the second set of components of the logical network includes machines (e.g., virtual machines (VMs)), a set of one or more logical switches, and logical ports of the set of logical switches to which the machines connect. In some embodiments, the two machines between which the packet is exchanged are VMs of the logical network, while in other embodiments, the machines are containers of the container network built on top of the logical network or a combination of VMs and containers. The third set of components of the physical underlay third network includes host computers on which one of the two machines executes and at least one host computer on which one or more physical forwarding elements that are used to implement a logical forwarding element execute, in some embodiments.

Each component traversed by the packet, in some embodiments, performs one or more actions on the packet as part of the trace operations in order to collect trace data. Examples of actions performed as part of the trace operations of some embodiments include packet tracing, packet capture, and packet counting. In some embodiments, packet capture is used to analyze packets to grant visibility in order to identify and/or troubleshoot network issues. Packet counting, in some embodiments, provides insight into how many packets (and/or how much data) are received and processed by each packet processing pipeline of each computing device traversed by packet flows for which the live packet monitoring session is performed. In some embodiments, packet count can be useful for identifying packet loss, as well as which packets are being dropped based on packet identifiers associated with the packets. Other monitoring actions in some embodiments may include packet flow statistics accumulation, packet latency measurement, or other packet monitoring measurements. After processing the packet, each container in the container network traversed by the packet encapsulates the packet with a first header (e.g., Geneve header), and each machine in the logical network traversed by the packet encapsulates the packet with a second header, in some embodiments.

In some embodiments, the first and second sets of trace data are received by the federation controller having different formats. As such, after using the correlation data to correlate the first and second sets of trace data, the federation controller of some embodiments translates the correlated trace data to a common format in order to generate the final trace report. The complete path identified in the final trace report includes identifications of each component in the system traversed by the packet, according to some embodiments. The final trace report of some embodiments also includes other trace data collected by the components, such as metrics collected during any additional operations performed on the packet as part of the trace operations. In some embodiments, the final trace report is subsequently provided to a network administrator through a UI for further analysis (e.g., identifying network issues) and is used, in some embodiments, to determine modifications to be made to the components of the system (e.g., to mitigate any anomalies identified through the packet trace).

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 illustrates a diagram of a system of some embodiments that includes two network platforms across which a trace packet is to be exchanged and processed.

FIG. 2 conceptually illustrates a process for performing a packet trace in a system that includes at least two network layers, in some embodiments.

FIG. 3 conceptually illustrates a diagram of a system as a packet trace is being performed in some embodiments.

FIG. 4 conceptually illustrates a process performed by edge forwarding routers in some embodiments to process trace packets.

FIG. 5 conceptually illustrates a diagram during a bidirectional packet tracing operation of some embodiments.

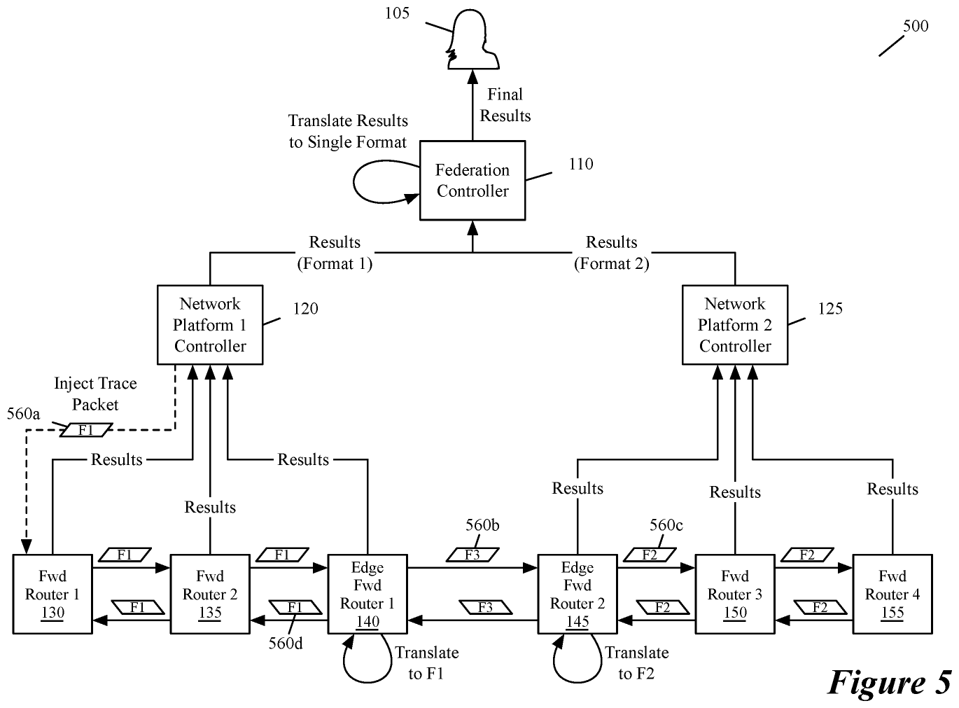

FIG. 6 conceptually illustrates a logical view of a logical switching element and a virtual switching element that are implemented in a physical network of some embodiments.

FIG. 7 conceptually illustrates an example of a path between first and second pods operating on first and second worker nodes that execute on the same host, in some embodiments.

FIG. 8 conceptually illustrates a diagram corresponding to the example path described for FIG. 7.

FIG. 9 conceptually illustrates an example of a path of some embodiments between pods executing in different worker nodes on different host computers separated by intervening network fabric.

FIG. 10 conceptually illustrates a diagram corresponding to the example path described above in FIG. 9.

FIG. 11 conceptually illustrates a process of some embodiments for performing a layered packet trace in a system of heterogeneous networks.

FIG. 12 illustrates a diagram of a system of some embodiments in which a packet trace between a source in a datacenter and a destination in a service cloud is performed.

FIG. 13 conceptually illustrates the trace packet of FIG. 12 in some embodiments as it is marked with a global packet identifier and encapsulated by the forwarding elements it traverses.

FIG. 14 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for performing data traffic monitoring for a system that includes a set of heterogeneous networks that includes at least an overlay first network layer that is built on top of an underlay second network layer. The method is performed in some embodiments by a federation controller for the system. The method directs (1) a first set of components in the overlay first network layer to perform a first trace operation to trace a packet exchanged between two machines and passing through network components defined in the overlay first network layer and underlay second network layer, and (2) a second set of components in the underlay second network layer to perform a second trace operation to trace the packet. From the first and second sets of components, the method receives first and second sets of trace data that were collected during the first and second trace operations and that include correlation data for correlating the first and second sets of trace data. The method uses the correlation data to correlate the first and second sets of trace data to generate a final trace report identifying a complete path traversed by the packet through the overlay first network layer and underlay second network layer.

In some embodiments, the federation controller directs the first and second sets of components to perform the first and second trace operations by providing a first trace request to a first controller for the overlay first network and a second trace request to a second controller for the underlay second network. The first and second controllers then direct the first and second sets of components to perform the first and second trace operations to trace the packet based on the first and second trace requests, according to some embodiments. Prior to providing the first and second trace requests to the first and second controllers, the federation controller of some embodiments translates a trace request received from a network administrator (e.g., through a user interface (UI)) into first and second formats that are compatible with the overlay first and underlay second networks, respectively, such that the first trace request has the first format and the second trace request has the second format, in some embodiments.

The federation controller, in some embodiments, receives the first and second sets of trace data from the first and second sets of components through the first and second controllers for the overlay first and underlay second networks. In some embodiments, the first and second controllers collect trace data from the first and second sets of components as the first and second trace operations are performed, and provide the collected trace data to the federation controller as first and second sets of trace data. The correlation data, in some embodiments, is included with the first and second sets of trace data based on instructions included with the first and second trace requests from the federation controller. The correlation data of some embodiments includes a marker identifying the trace data as trace data associated with the first or second trace operations. Also, in some embodiments, only one of the sets of trace data for the packet includes the correlation data.

In some embodiments, the overlay first network layer is a container network and the underlay second network is a logical network built on top of a physical underlay third network that includes a third set of components. The first set of components of the container network includes a set of one or more containers, in some embodiments. The containers of some embodiments are implemented in pods, with each pod executing one or more containers. In some embodiments, the second set of components of the logical network includes machines (e.g., virtual machines (VMs)), a set of one or more logical switches, and logical ports of the set of logical switches to which the machines connect. In some embodiments, the two machines between which the packet is exchanged are VMs of the logical network, while in other embodiments, the machines are containers of the container network built on top of the logical network or a combination of VMs and containers. The third set of components of the physical underlay third network includes host computers on which one of the two machines executes and at least one host computer on which one or more physical forwarding elements that are used to implement a logical forwarding element execute, in some embodiments.

Examples of actions performed as part of the trace operations of some embodiments include packet tracing, packet capture, and packet counting. In some embodiments, packet capture is used to analyze packets to grant visibility in order to identify and/or troubleshoot network issues. Packet counting, in some embodiments, provides insight into how many packets (and/or how much data) are received and processed by each packet processing pipeline of each computing device traversed by packet flows for which the live packet monitoring session is performed. In some embodiments, packet count can be useful for identifying packet loss, as well as which packets are being dropped based on packet identifiers associated with the packets. Other monitoring actions in some embodiments may include packet flow statistics accumulation, packet latency measurement, or other packet monitoring measurements. After processing the packet, each container in the container network traversed by the packet encapsulates the packet with a first header (e.g., Geneve header), and each machine in the logical network traversed by the packet encapsulates the packet with a second header, in some embodiments.

In some embodiments, the first and second sets of trace data are received by the federation controller having different formats. As such, after using the correlation data to correlate the first and second sets of trace data, the federation controller of some embodiments translates the correlated trace data to a common format in order to generate the final trace report. The complete path identified in the final trace report includes identifications of each component in the system traversed by the packet, according to some embodiments. The final trace report of some embodiments also includes other trace data collected by the components, such as metrics collected during any additional operations performed on the packet as part of the trace operations. In some embodiments, the final trace report is subsequently provided to a network administrator through a UI for further analysis (e.g., identifying network issues) and is used, in some embodiments, to determine modifications to be made to the components of the system (e.g., to mitigate any anomalies identified through the packet trace).

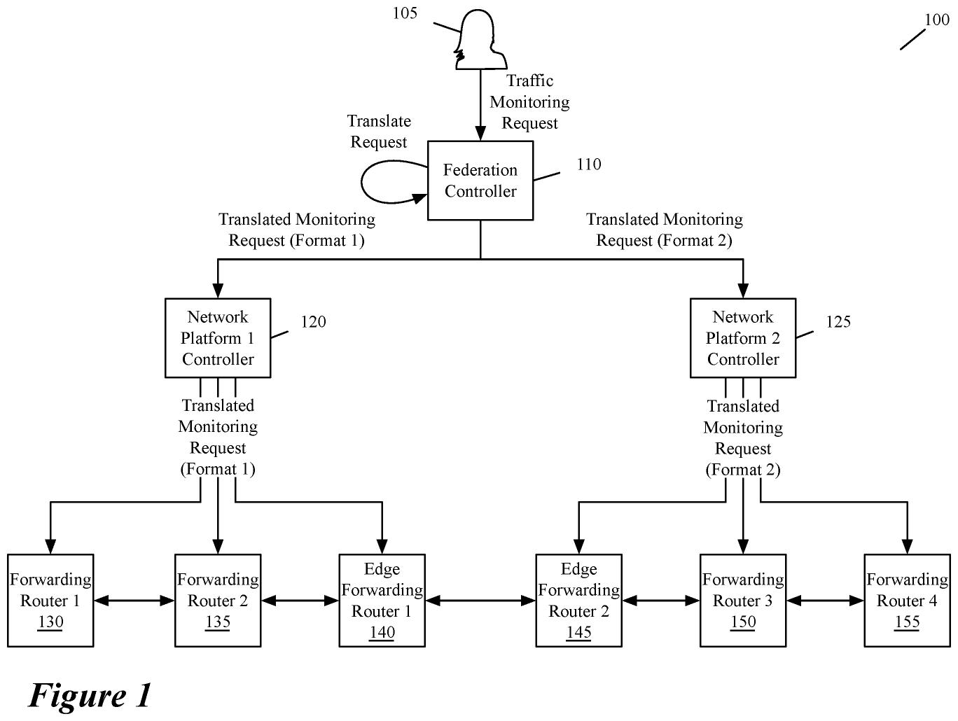

FIG. 1 illustrates a diagram of a system of some embodiments that includes two network platforms across which a trace packet is to be exchanged and processed. As shown, the diagram 100 includes a federation controller 100 that manages the system, a network platform controller 120 for managing forwarding routers 130-135 and the edge forwarding router 140, and network platform controller 125 for managing forwarding routers 150-155 and edge forwarding router 145. The forwarding routers 130-135 and 150-155 are forwarding elements operating on host computers and machines (e.g., VMs) in some embodiments. Also, while illustrated as single components, the controllers 120 and 125 are controller clusters in some embodiments.

To initiate a trace operation, in some embodiments, a network administrator 105 sends a traffic monitoring request to the federation controller 110 (e.g., through a UI provided by the federation controller). Upon receiving the request, the federation controller 110 of some embodiments translates the request into formats that are compatible with the different network platforms of the system. The network platforms, in some embodiments, include overlay network layers built on top of underlay network layers. For example, the first and second network platforms in some embodiments are a container network implemented on top of a logical network.

Once the federation controller 110 has translated the traffic monitoring request, it provides the translated request to the network platform controllers 120 and 125. As illustrated, the network platform controller 120 receives the translated monitoring request in format 1, while the network platform controller 125 receives the translated monitoring request in format 2. The network platform controllers 120 and 125 then distribute the monitoring requests to their respective forwarding routers 130-135 and 150-155, and their respective edge forwarding routers 140-145.

In some embodiments, the monitoring requests include specific actions to be performed on the trace packet. For example, the monitoring requests of some embodiments may specify operations such as packet tracing, packet capture, and packet counting. In some embodiments, packet capture is used to analyze packets to grant visibility in order to identify and/or troubleshoot network issues. Packet counting, in some embodiments, provides insight into how many packets (and/or how much data) are received and processed by each packet processing pipeline of each computing device traversed by packet flows for which the live packet monitoring session is performed. In some embodiments, packet count can be useful for identifying packet loss, as well as which packets are being dropped based on packet identifiers associated with the packets. Other monitoring actions in some embodiments may include packet flow statistics accumulation, packet latency measurement, or other packet monitoring measurements.

After processing the packet, some of the components traversed by the packet are configured to encapsulate the packet with a header associated with the network platform to which the component belongs. For example, containers and pods belonging to a container network encapsulate the packet with, e.g., a Geneve header, in some embodiments. Each component that processes the packet may include a designated packet processing pipeline, in some embodiments, that includes various stages for performing the actions specified for the packet trace operations. The stages of the packet processing pipeline are performed, in some embodiments, by one or more forwarding elements (e.g., software forwarding elements (SFEs)) and/or other modules (e.g., firewall engines, filter engine, etc.) executing on the component (e.g., in virtualization software of a host computer). In some embodiments, the stages of the packet processing pipeline also perform routine standard operations on the trace packet (e.g., by applying firewall rules and/or other service rules).

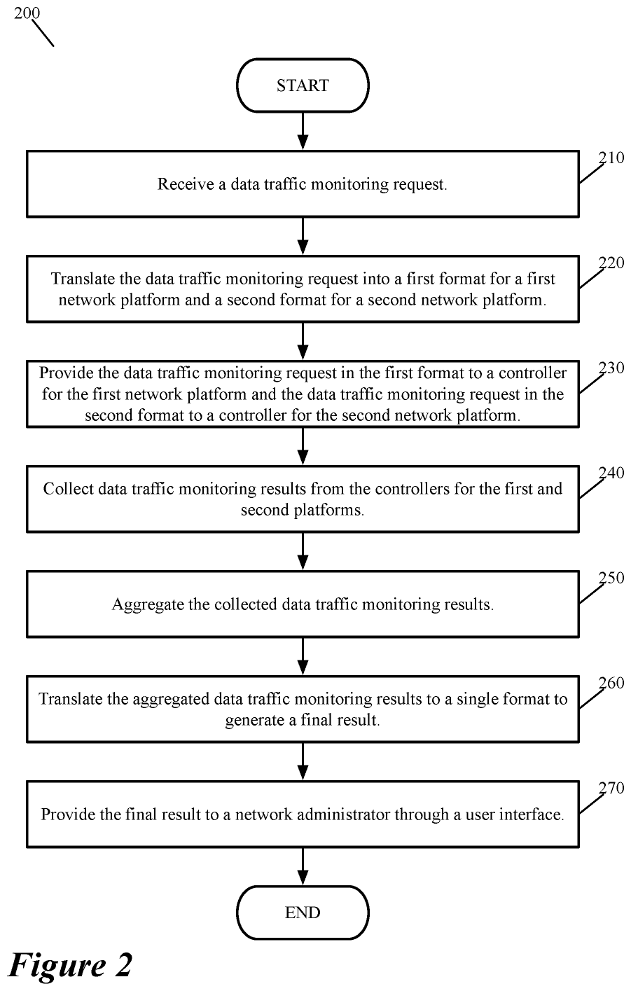

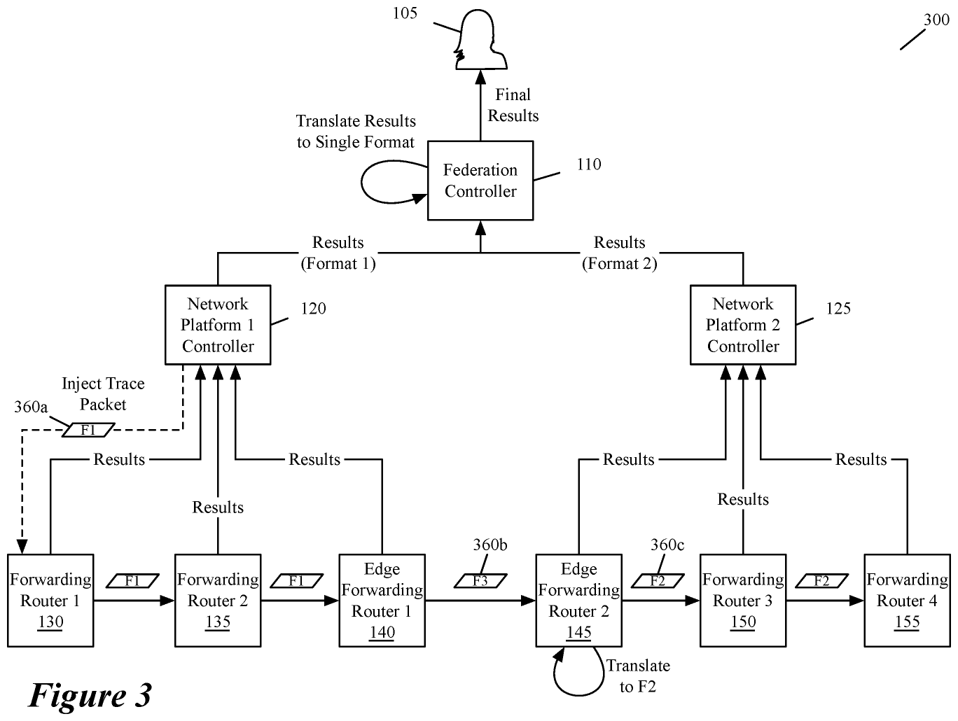

FIG. 2 conceptually illustrates a process for performing a packet trace in a system that includes at least two network layers, in some embodiments. The process 200 is performed, in some embodiments, by a federation controller of a system, such as the federation controller 110. The process 200 will be described by reference to FIG. 1 and FIG. 3, which illustrate diagram 100 and 300 of the system, respectively, as the packet trace is being performed. The process 200 starts when the federation controller receives (at 210) a data traffic monitoring request. For example, the federation controller 110 in the diagram 100 receives a data traffic monitoring request from the network administrator 105, as discussed above.

The process 200 translates (at 220) the data traffic monitoring request into a first format for a first network platform and a second format for a second network platform. For instance, the system of some embodiments may include a container network built on top of a software-defined network (SDN), and the federation controller translates the received request into different formats for each respective network layer to enable each respective network layer to perform the trace operations.

The process 200 provides (at 230) the data traffic monitoring request in the first format to a controller for the first network platform and the data traffic monitoring request in the second format to a controller for the second network platform. In the diagram 100, for instance, the network platform controller 120 is provided the traffic monitoring request in a first format and the network platform controller 125 is provided the traffic monitoring request in a second format. By providing the traffic monitoring request to the different network platforms in formats compatible with the different network platforms, a full view of the path of the trace packet as it traverses components of the different network platforms can be achieved, according to some embodiments.

In some embodiments, the federation controller provides correlation data to the network platform controllers for distribution to network components for marking the trace packet and collected trace results. The correlation data, in some embodiments, includes a global trace identifier allocated by the federation controller for the monitoring session. In other embodiments, the requests provided by the federation controller specify for each network platform controller to generate their own correlation data, which may include each network platform controller allocating their own respective trace identifier. In some such other embodiments, before the trace packet is injected, the federation controller gathers the respective correlation data (e.g., trace identifiers) from each network platform controller, and specifies for each platform controller which trace mark identifier to filter in the trace packet, and which trace mark identifier to add to an outer header of the trace packet.

As illustrated by the diagram 300, the network platform controller 120 injects a trace packet 360a having the first format (“F1”) into the forwarding router 130. In some embodiments, the trace packet is injected by the source machine (e.g., forwarding router 130) upon instruction from the network platform controller. The trace packet traverses each of the forwarding routers 130 and 135, which mark the trace packet according to specifications from the network platform controller, and provide results that include correlation data (e.g., trace data that includes a trace marker for the traffic monitoring session) to their respective network platform controller 120. The trace packet is then processed and forwarded by the edge forwarding router 140 to the edge forwarding router 145. As the trace packet is forwarded between the edge forwarding routers 140 and 145, the trace packet 360b may be in a format other than the first or second formats (e.g., “F3”). For instance, the trace packet 360b may be encapsulated with a particular header by the edge forwarding router 140 before it is forwarded, e.g., across an intervening network, to the edge forwarding router 145.

Upon receiving the trace packet 360b, the edge forwarding router 145 translates the trace packet to a second format (“F2”) for the second network platform, and forwards the translated packet 360c to the forwarding router 150 for processing and forwarding to the final destination forwarding router 155. Like the forwarding routers 130-135 and edge forwarding router 140, the forwarding routers 150-155 and edge forwarding router 145 marks the packet and provides trace results to their respective network platform controller 125. The network platform controllers 120 and 125 aggregate the results received from the forwarding and edge forwarding routers, and provide the aggregated results to the federation controller 110 in their respective formats, according to some embodiments. In other embodiments, each of the network platform controllers 120-125 sends the results to the federation controller 110 on a periodic basis (e.g., at specific time intervals, or after collecting a particular amount of results) without aggregating.

Returning to the process 200, the process collects (at 240) data traffic monitoring results from the controllers for the first and second platforms. That is, in some embodiments, rather than the network platform controllers 120 and 125 providing the results to the federation controller 110, the federation controller 110 instead retrieves the results from the network platform controllers. In some embodiments, the network platform controllers 120-125 provide the trace results to a data store that is separate from the federation controller, and the federation controller 110 collects the trace results from the data store. In other embodiments, the data store is part of the federation controller 110.

The process 200 aggregates (at 250) the collected data traffic monitoring results. In some embodiments, the results from each network platform include correlation data, such as a global trace marker or different trace markers corresponding to each network platform, for use in correlating and aggregating the trace results, as mentioned above. The correlation data of some embodiments may include a specific set of characteristics associated with the trace packet's flow, such as a flow identifier (e.g., five-tuple identifier). Also, in some embodiments, the correlation data may include information regarding how the trace results should be correlated and aggregated.

The process 200 translates (at 260) the aggregated data traffic monitoring results to a single format to generate a final result. Because the results collected from controllers for each network platform have different formats based on the network platform from which they are collected, the aggregated results do not have a common format. As such, the federation controller 110 translates the results to a common format to generate a uniform report of the final results, in some embodiments. The process 200 then provides (at 270) the final result to the network administrator through the UI (i.e., the UI through which the request was received). Following 270, the process 200 ends.

In some embodiments, the network administrator analyzes the final results to identify any areas in the system experiencing network issues. As described above, for example, packet count can be useful for identifying packet loss, as well as which packets are being dropped based on packet identifiers associated with the packets (e.g., packets between a particular source and destination). Other metrics, such as latency, can be deduced from the final results, in some embodiments, and used to identify components exhibiting anomalous behavior.

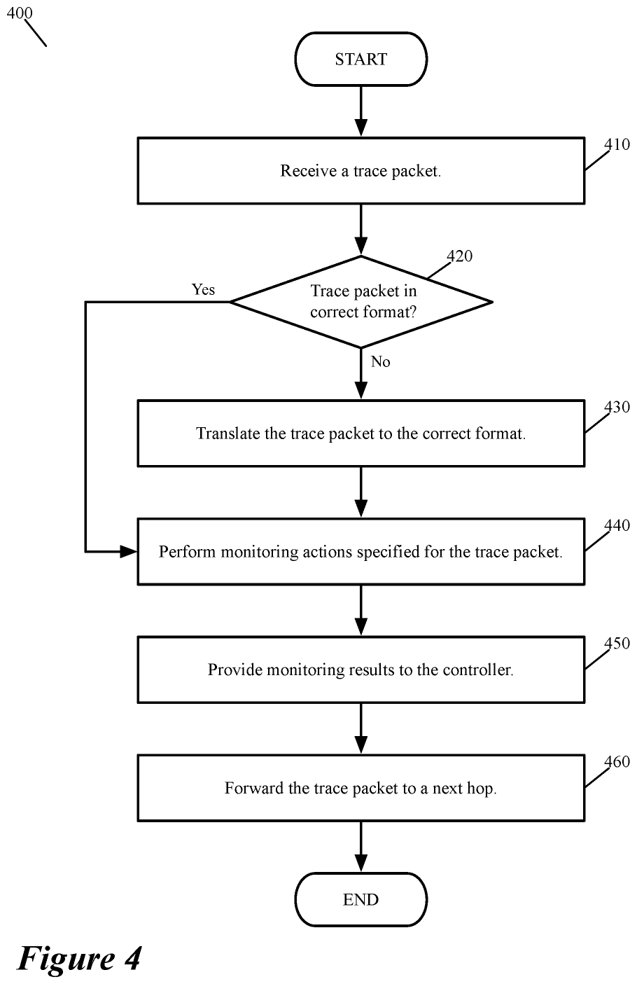

FIG. 4 conceptually illustrates a process performed by edge forwarding routers in some embodiments to process trace packets. The process 400 will be described with references to Figure which illustrates a diagram 500 during a bidirectional packet tracing operation of some embodiments.

The process 400 starts when the edge forwarding router receives (at 410) a trace packet. In the diagram 500, a trace packet 560a is injected to the source forwarding router 130. The trace packet 560a is then processed and forwarded by the source forwarding router 130, forwarding router 135, and edge forwarding router 140, which forwards the trace packet to the edge forwarding router 145. Like the embodiments described above, as the trace packet traverses, e.g., an intervening network (not shown) between the edges, the trace packet 560b may be encapsulated and have a format other than the first or second formats. The edge forwarding router 145 then receives the trace packet 560b.

The process 400 then determines (at 420) whether the trace packet is in the correct format (i.e., the format compatible with the edge's respective network platform). When the packet is in the correct format (e.g., is received from another component belonging to the same network platform), the process transitions to 440. Otherwise, when the packet is not in the correct format, the process transitions to translate (at 430) the trace packet to the correct format. In some embodiments, for instance, the edge forwarding router translates the trace packet from one encapsulation format to another.

In the diagram 500, for instance, the edge forwarding router 145 translates the trace packet 560b to the format for the second network platform (“F2”) and forwards the translated packet 560c to the forwarding router 150. For the return trace packet, the edge forwarding router 140 translates the trace packet back to the format for the first network platform (“F1”), and forwards the translated trace packet 560d to the forwarding router 135, as illustrated.

The process 400 performs (at 440) monitoring actions specified for the trace packet. As described above, the trace operations of some embodiments include actions such as packet trace, packet count, and packet capture. The edge forwarding routers of some embodiments may be configured to perform one or more of these actions on the trace packet. In some embodiments, the translation performed in step 430 above is specified as one of the actions to be performed by the edge forwarding router for packets matching specific criteria (i.e., packets having the incorrect format). In addition to actions performed as part of the packet trace operation, the edge forwarding routers of some embodiments are also configured to perform one or more standard operations as part of processing the trace packet (e.g., applying one more firewall rules or other service rules to the trace packet).

The process 400 then provides (at 450) the trace monitoring results to the controller for the edge forwarding router's respective network platform, and forwards (at 460) the trace packet to a next hop. For example, each of the edge forwarding routers 140 and 145 are illustrated in the diagram 500 as forwarding the trace packet and providing results to the respective controllers 120 and 125. Following 460, the process 400 ends.

As discussed above, the different network platforms of some embodiments are overlay networks built on top of underlay networks. Because the underlay network has no knowledge of operations in the overlay network, and the overlay network has no knowledge of operations in the underlay network, performing a packet trace operation that includes tracing a packet traversing both the overlay and underlay networks requires different trace operations being performed by the different networks, with the federation controller correlating and aggregating the trace results from each network using correlation data included in the trace results.

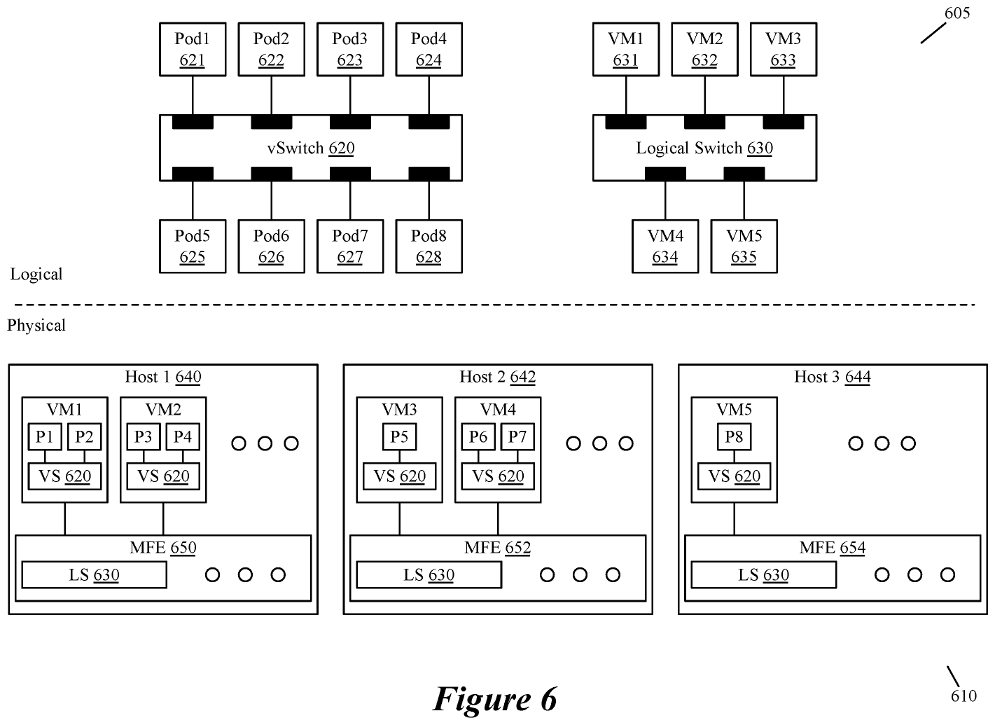

FIG. 6 conceptually illustrates a logical view 605 of a logical switching element 630 and a virtual switching element 620 that are implemented in a physical network 610. As shown, the logical switching element 630 connects five VMs 631, 632, 633, 634, and 635. Each of these VMs 631-635 connects to a logical port of the logical switching element 630. Additionally, the virtual switching element 620 connects eight pods 621, 622, 623, 624, 625, 626, 627, and 628. Each of these pods 621-628 connects to a virtual interface of the virtual switching element 620. In some embodiments, a user (e.g., network administrator) defines the logical switching element 630, which may be part of a larger logical network, and the virtual switching element 620, which may be part of a container network built on top of (e.g., nested within) the larger logical network. For instance, the logical switching element may include a logical port that connects to an external gateway (e.g., to an external network), to a logical L3 router (which may also connect to other logical L2 switches), etc. The virtual switching element, in some embodiments, may include one or more interfaces (e.g., tunnel interfaces, gateway interfaces, etc.) for connecting to logical ports of the logical switching elements.

In some embodiments, the user defines the logical switching element 630 and the virtual switching element 620 through application programming interfaces (APIs) of network controllers designated for the logical network and container network, which translate the user definitions into logical control plane definitions of the logical switching element 630 and virtual switching element 620. In other embodiments, the user defines the logical and virtual switching elements through APIs of a federation controller, which translates and provides the definitions to the respective network controllers. The network controllers then convert the respective logical control plane definitions into logical forwarding plane specifications of the logical and virtual switching elements, respectively. The logical forwarding plane specifications, in some embodiments, include logical forwarding table entries (logical flow entries) that specify rules for forwarding packets to logical ports of the logical switching element. For instance, the logical control plane of some embodiments includes bindings between MAC addresses of VMs and logical ports, and the logical forwarding plane specifies flow entries for forwarding packets to the logical ports based on matches of the MAC addresses.

In addition, the network controllers of some embodiments convert the logical forwarding plane data into physical control plane data that specifies rules for managed forwarding elements (MFEs) to follow in order to implement the logical and virtual switches. This physical control plane data includes matches over the logical and virtual switches themselves (e.g., based on a source of a packet), as well as entries for placing packets into tunnels from one managed forwarding element to another (and receiving packets from these tunnels). These rules, in some embodiments, incorporate data from the managed forwarding elements, such as physical ports and tunnel IP address information. The network controller then pushes this physical control plane data down to the MFEs.

The controllers, as mentioned, push these flow entries to several MFEs in some embodiments, such that the logical and virtual switching elements (and/or other logical forwarding elements, such as logical routers) are implemented in distributed, virtualized fashions. The physical network 610 of FIG. 6 illustrates that the five VMs 631-635 are hosted on three different host machines 640, 642, and 644, while the eight pods 621-628 are distributed across the five VMs 631-635. Some embodiments may only host one VM from a particular logical network on a single machine, while other embodiments may put multiple VMs from a logical network on the same machine, as in this case with the hosts 640 and 642. While each of the VMs 631-635 includes at least one pod, other embodiments may include VMs that do not include any pods, as well as pods that execute directly on the hosts rather than within the VMs. As shown, in the virtualized environment, each of these hosts 640-644 also hosts additional VMs beyond those connected to the logical switch 630. That is, many tenants may share the use of the physical network 610, and in fact may share use of a single physical host. One or more of the additional VMs may include one or more additional pods, in some embodiments.

Each pod 621-628 is a group of one or more containers that share storage and network resources, according to some embodiments. The containers of the pod, in some embodiments, are tightly-coupled application containers. In some embodiments, pods belonging to different subnets execute on the same worker nodes (e.g., VMs), and pods belonging to the same subnet execute on different worker nodes, with each subnet having a corresponding namespace shared by pods belonging to the subnet.

Operating on each host (e.g., within virtualization software on the host) is an MFE 650, 652, and 654, as shown. The MFEs, in some embodiments, are software forwarding elements (SFEs) to which the network controller for the logical network connects and pushes down flow entries for various logical forwarding elements. In this case, because VMs from the logical switch 630 are located on each of the three illustrated hosts 640-644, the respective MFEs 650-654 in each of these hosts implements the logical switching element 630. That is, each of the illustrated MFEs 650-654 has flow entries in its forwarding tables (not shown) for logically forwarding packets to the logical ports associated with the different VMs 631-635.

In some embodiments, one or more of the MFEs 650-654 have direct tunnel connections between them for forwarding packets between the hosts 640-644. In addition to the direct connections between two or more of the MFEs, some embodiments also include one or more forwarding elements (not shown) external to the hosts 640-644 connecting to each of the hosts within the network, and serve to forward packets between edge MFEs (those located in the hosts, at the edge of the network). In some such embodiments, each MFE has a tunnel defined to a port of the external forwarding element (or to each of multiple external forwarding elements). In some embodiments, packets sent along each of these tunnels pass through one or more unmanaged forwarding elements (e.g., standard, dedicated routers) that do not receive flow entries from the network controller and pass along the packets with only minimal processing.

Within the above-described environment, in some embodiments, controllers for the logical network and for the container network receive a request from a federation controller that manages a system that includes both the logical and container networks. A user (e.g., a network administrator), using one of a variety of user interface tools, designs a packet to be traced through the system managed by the federation controller, which translates the trace request into formats compatible with the logical network and container network, respectively, and provides the translated trace requests to controllers for each network. In addition to the source and destination addresses, the user may specify whether to trace a broadcast packet (i.e., instead of a specific destination address), a payload for the packet, the packet size, or other information, according to some embodiments.

The network controller for the network that includes the source defined for the packet then generates the packet, and in some embodiments inserts an indicator into a particular location in the packet that specifies the packet as a traced packet. For instance, some embodiments use a single bit at a specific location in the packet header (e.g., a logical VLAN field) that flags the packet as being used for a trace operation. The network controller then injects the packet to the source defined for the packet, or to a forwarding element to which the source of the packet connects. The network controllers for both the logical and container networks then await receipt of results (e.g., observations, packet metrics, trace data) from the forwarding elements through which the packet passes.

In some embodiments, each component traversed by the packet sends results to their respective network controller in two situations: (1) when sending a traced packet over a tunnel, and (2) when delivering a traced packet to a logical port (though some embodiments do not actually deliver the packet, but instead drop the packet while sending the observation). If the packet is never sent out from the forwarding element connected to the initial source (e.g., because of an access control list operation that drops the packet), then no results will be sent to the network controllers. In some embodiments, the packet tracing operations operate with a specified timeout after which the network controllers, and subsequently the federation controller, and assume that no additional results will be delivered. Other than sending the results and not actually delivering the packet to a VM or pod (or other destination bound to a logical port), the forwarding elements process the packet in the same manner as an unmarked packet actually received from a VM or pod. In some embodiments, while processing a packet through several stages, managed switching elements store a register bit indicating that the packet is marked for a trace operation.

In order to send results to the network controllers, the forwarding tables of the forwarding elements of some embodiments include entries that specify when the results should be sent. In some embodiments, these results include (i) the packet being processed by the forwarding element as received, and (ii) the contents of the registers for the packets, from which the network controllers and federation controller can identify the relevant data. The forwarding table entry for sending the results, in some embodiments, specifies to the forwarding element to copy certain data to the register and then send the register contents to the respective network controller.

Once the network controllers receive the results (or the timeout is reached), the network controllers of some embodiments aggregate the results and provide the aggregated results to the federation controller, which generates a final report and provides it (e.g., via a UI) to the requesting user. In some embodiments, this report indicates whether the packet was delivered, identifies each component traversed by the trace packet, and provides information about each of the received results.

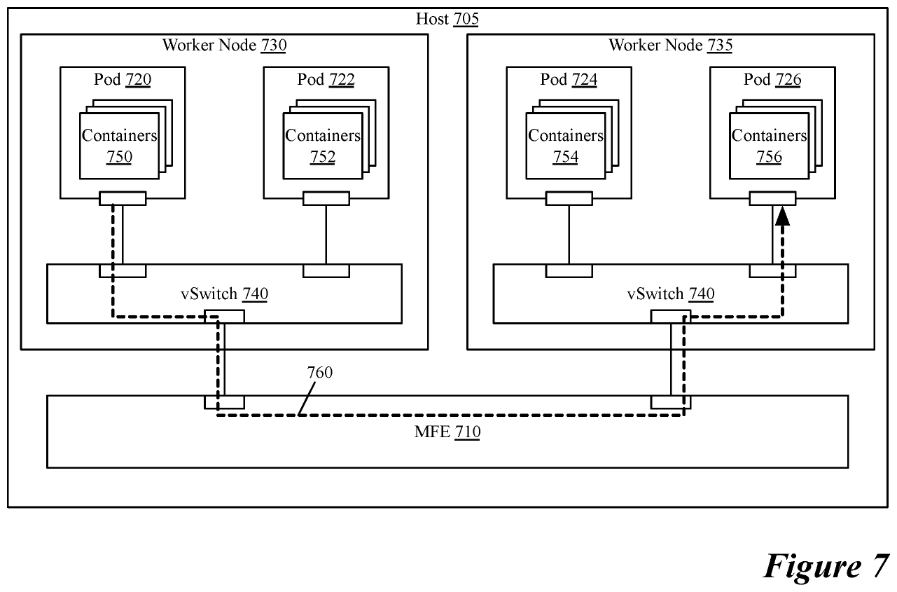

In some embodiments, the packet trace is performed for packets sent between pods operating within different worker nodes (e.g., VMs) executing on the same host (e.g., physical host computer, a virtual host machine, etc.). FIG. 7 conceptually illustrates an example of such a path between first and second pods operating on first and second worker nodes that execute on the same host. As illustrated, the host 705 includes two worker nodes 730 and 735, as well as an MFE 710. The MFE 710, like the MFEs 650-654, is an SFE, in some embodiments, that implements one or more logical switches that each includes logical ports to which the worker nodes 730 and 735 connect, as shown.

The worker node 730 includes a virtual switch 740 having virtual interfaces to which each of the pods 720 and 722 connects. Similarly, the worker node 735 also includes the virtual switch 740 having virtual interfaces to which each of the pods 724 and 726 connects. As described above, each pod is a group of containers. Accordingly, the pod 720 includes a group of containers 750, the pod 722 includes a group of containers 752, the pod 724 includes a group of containers 754, and the pod 726 includes a group of containers 756.

The virtual switch 740, in some embodiments, is an Open vSwitch (OVS) distributed across the worker nodes 730 and 735. OVS is a widely adopted high-performance programmable virtual switch, originating from VMware, Inc., that is designed to enable effective network automation through programmatic extensions. In some embodiments, the container network is a Kubernetes-based container network implemented using the Antrea networking solution, which leverages OVS in its architecture to efficiently implement pod networking and security features.

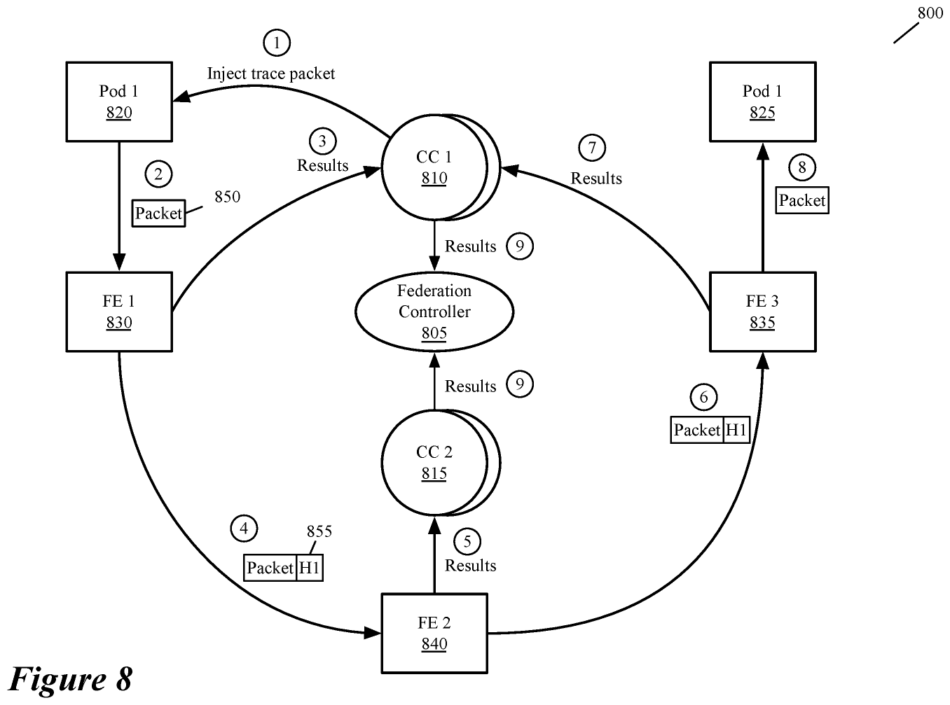

As shown, the example path 760 in FIG. 7 is between the pod 720 on the worker node 730 and the pod 726 on the worker node 735. The pod 720 forwards a trace packet via a virtual interface to the virtual switch 740 on the worker node 730. The virtual switch 740 on the worker node 730 then processes the packet (e.g., according to the trace request as well as any other standard processing configured for the virtual switch), and encapsulates the packet with an encapsulation header (e.g., a Geneve header) and forwards the packet to a logical port of the MFE 710, which implements one or more logical switches. The MFE 710 processes the packet, and logically forwards the packet to the virtual switch 740 via a logical port associated with the worker node 735. The virtual switch 740 on the worker node 735 decapsulates the packet, processes the packet, and provides the packet to its destination pod 726, as shown. As each forwarding element processes the packet, results associated with the trace are sent to each forwarding element's respective network controller, according to some embodiments, as will be described below by reference to FIG. 8.

FIG. 8 conceptually illustrates a diagram 800 corresponding to the example path described for FIG. 7. As shown, a first network controller cluster 810 injects a trace packet (at the encircled 1) to the source pod 820. The pod 820 then forwards (at the encircled 2) the packet 850 to the forwarding element 830. The forwarding element 830 is a virtual switch, in some embodiments, such as the virtual switch 740 described above. The forwarding element 830 processes the packet 850, and sends trace results (e.g., trace data associated with any trace operations performed on the trace packet) to the network controller cluster 810 (at the encircled 3). The forwarding element 830 then encapsulates the packet with a header 855 and forwards the encapsulated packet to the forwarding element 840 (at the encircled 4). The header 855 is a Geneve header, or any other OVS-supported protocol, according to some embodiments.

The forwarding element 840, in some embodiments, is a logical switch implemented by an MFE executing on a host machine, such as the MFE 710. In other embodiments, the forwarding element 840 may be a logical router, or other type of forwarding element used to forward packets between worker nodes in which source and destination pods execute. The forwarding element 840 processes the packet, and provides results (at the encircled 5) to its respective network controller cluster 815. In some embodiments, the only trace-related operations performed on the packet 850 by the forwarding element 840 is a packet count operation to indicate that the packet traversed the forwarding element 840 along its path. The forwarding element 840 then forwards the still-encapsulated packet (at the encircled 6) to the forwarding element 835.

The forwarding element 835 is the same distributed virtual switch as the forwarding element 830, in some embodiments. The forwarding element 835 decapsulates the packet 850 (i.e., removes the encapsulation header 855), processes the packet, and provides trace results (at the encircled 7) to its respective network controller cluster 810. The forwarding element 835 then delivers the packet (at the encircled 8) to the destination pod 825. In some embodiments, the results provided by the forwarding element 835 to the network controller cluster 810 include an indication that the forwarding element 835 is the forwarding element logically connected to the destination of the packet, in order to inform the network controller cluster 810 that the packet trace is completed (or near-completed). In some embodiments, the network controller cluster 810 and the network controller cluster 815 determine that the packet trace is complete when no additional results are received after a specified period of time. The network controller clusters 810 and 815 then provide the results collected from the forwarding elements to the federation controller 805.

The federation controller 805 correlates and aggregates the received trace results in order to generate a final report that identifies the path traversed by the trace packet, including each network element that processed the trace packet along the path, as well as any additional trace data included in the results (e.g., packet count metrics, latency measurements, etc.). In some embodiments, the correlation data is only included in results from one of the network controllers, and used to correlate data from both network controllers. In other embodiments, the correlation data includes a marker identifying the particular trace as well as which respective network layer (e.g., overlay container network layer, or logical underlay network layer) generated the data. After generating the final report, the federation controller 805 provides the report (e.g., through a UI) to the requesting user (e.g., network administrator that requested the trace).

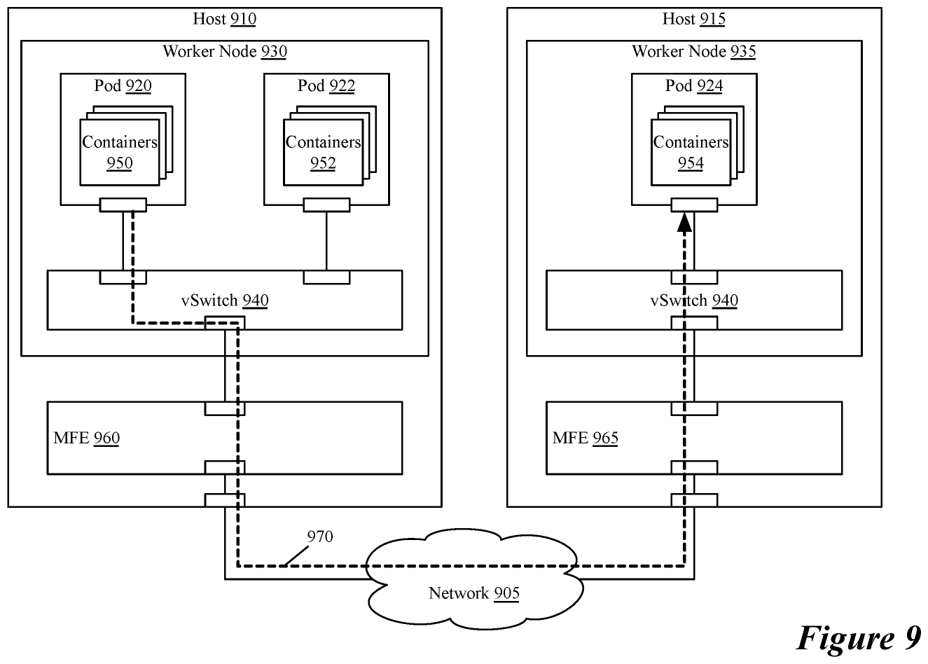

In some embodiments, traced packets that traverse additional elements of the logical underlay network on top of which the container network is built necessitate the traced packets to be encapsulated with a second header by the forwarding elements of the logical underlay network. For example, FIG. 9 conceptually illustrates an example of a path of some embodiments between pods executing in different worker nodes on different host computers separated by an intervening network fabric.

Each of the host computers 910 and 915 includes a respective worker node 930 and 935 and a respective MFE 960 and 965. In other embodiments, the hosts 910 and 915 may include additional MFEs and additional worker nodes, or other machines that may or may not execute elements of an overlay network (e.g., a container network built on top of the logical network). The worker node 930 on the host 910 includes a pod 920 that includes a group of containers 950 and a pod 922 that includes a group of containers 952, while the worker node 935 on the host 915 includes a pod 924 that includes a group of containers 954. Each of the pods 920-924 logically connects (e.g., via virtual interfaces) to a virtual switch 940 distributed across the worker nodes 930 and 935.

The path 970 illustrates the path traversed by a packet sent from the pod 920 on the worker node 930 that executes on the host 910 to the pod 924 on the worker node 935 that executes on the host 915. After the pod 920 forwards the trace packet to the virtual switch 940 via a virtual interface designated for the pod 920, the virtual switch 940 performs one or more operations on the packet associated with the trace, as well as any operations configured for the virtual switch (e.g., applying firewall rules, services rules, etc.). The virtual switch 940 then encapsulates the packet with a header compatible with the container network to which the pod belongs (e.g., a Geneve header), and forwards the encapsulated packet to the MFE 960 that implements one or more logical switches having logical ports to which the virtual switch 940 connects.

The logical switch (not shown) implemented by the MFE 960 then performs any trace-related operations, and other standard operations, on the trace packet. In some embodiments, the MFE is an SFE that applies service rules to the trace packet, and, in some embodiments, provides the packet to a packet processing pipeline operating on the host computer for further processing. After the trace packet has been processed, it is encapsulated with a second header, and forwarded via a PNIC of the host 910 to the host 915 through the intervening network fabric 905.

The intervening network fabric, in some embodiments, includes wired or wireless connections, various network forwarding elements (e.g., switches, routers, etc.), etc. For instance, in some embodiments, the hosts 910 and 915 are connected together by one or more unmanaged forwarding elements. In other embodiments, the hosts 910 and 915 are virtual hosts operating on the same physical host computer and the intervening network fabric is an additional software switch connecting the hosts 910 and 915 to each other and to other network elements external to the physical host.

Once the trace packet arrives at the host 915 (e.g., at a PNIC of the host 915), the trace packet is forwarded to the MFE 965 for processing. The MFE 965 decapsulates the trace packet and removes the second header in order to process the trace packet. In some embodiments, as with the MFE 960 described above, the trace packet is forwarded via a port of the MFE to a packet processing pipeline for processing. Once the trace packet has been processed, the MFE 965 forwards the packet (e.g., via a logical port designated for the worker node 935) to the virtual switch 940 implemented on the worker node 935. The virtual switch 940 decapsulates the trace packet and removes the first encapsulation header (e.g., the Geneve header), and performs any required processing (trace and non-trace related), and delivers the packet to the destination pod 924 via a virtual interface to which the pod connects to complete the trace.

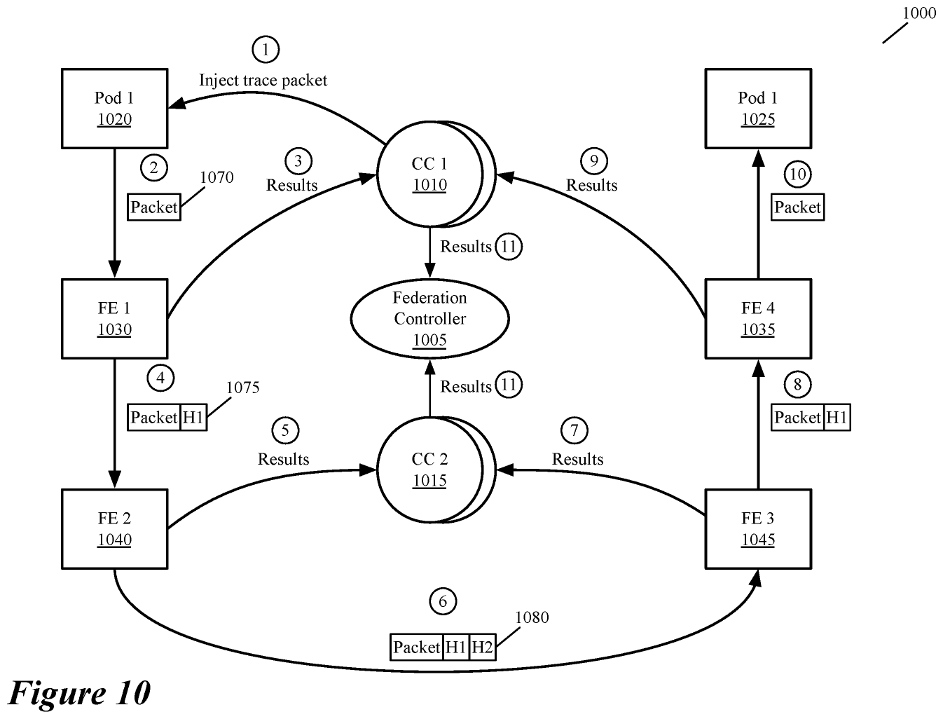

FIG. 10 conceptually illustrates a diagram 1000 corresponding to the example path 970 described above. As shown, a first network controller cluster 1010 injects a trace packet (at the encircled 1) to the source pod 1020. The pod 1020 then forwards (at the encircled 2) the packet 1070 to the forwarding element 1030. The forwarding element 1030 is a virtual switch, in some embodiments, such as the virtual switch 940 described above, that is distributed across multiple worker nodes and connected to various pods and container sets operating on the worker nodes. The forwarding element 1030 processes the packet 1070, and sends trace results (e.g., trace data associated with any trace operations performed on the trace packet) to the network controller cluster 1010 (at the encircled 3). The forwarding element 1030 then encapsulates the packet with a header 1075 and forwards the encapsulated packet to the forwarding element 1040 (at the encircled 4). The header 1075 is a Geneve header, or any other OVS-supported protocol, according to some embodiments.

The forwarding element 1040, in some embodiments, is a logical switch implemented by an MFE (e.g., an SFE) executing on a host machine, such as the MFE 960. The forwarding element 1040 processes the packet, and provides results (at the encircled 5) to its respective network controller cluster 1015. The forwarding element 1040 then encapsulates the packet 1070 with a second header 1080, and forwards the double-encapsulated packet (at the encircled 6) to the forwarding element 1045. In some embodiments the trace packet traverses intervening network fabric between the forwarding elements 1040 and 1045.

At the forwarding element 1045, the trace packet is decapsulated and the second header 1080 is removed. The forwarding element 1045 then processes the packet, and provides trace results (at the encircled 7) to the controller cluster 1015, as shown, and forwards (at the encircled 8) the packet 1070, still encapsulated with the first header 1075, to the forwarding element 1035. The forwarding element 1035 corresponds to the virtual switch 940 on the worker node 935 in FIG. 9.

The forwarding element 1035 decapsulates the packet 1070 and removes the header 1075. The forwarding element 1035 then processes the packet and provides the trace results (at the encircled 9) to the controller cluster 1010. The forwarding element 1035 then delivers (e.g., via a virtual interface designated for the pod) the trace packet 1070 to the pod 1025 (at the encircled at which time the trace is completed.

The network controller clusters 1010 and 1015 of some embodiments determine that the packet trace is complete when no additional results are received after a specified period of time, or based on an indicator provided by the last components of each network to receive and process the trace packet, according to some embodiments. The network controller clusters 1010 and 1015 then provide the trace results collected from the forwarding elements to the federation controller 1005 for correlation, aggregation, analysis, and report generation, in some embodiments.

The federation controller 1005 correlates and aggregates the received trace results in order to generate a final report that identifies the path traversed by the trace packet, including each network element that processed the trace packet along the path, as well as any additional trace data included in the results (e.g., packet count metrics, latency measurements, etc.). As described above, in some embodiments, the correlation data is only included in results from one of the network controllers, and used to correlate data from both network controllers. In other embodiments, the correlation data includes a marker identifying the particular trace as well as which respective network layer (e.g., overlay container network layer, or logical underlay network layer) generated the data. After generating the final report, the federation controller 1005 provides the report (e.g., through a UI) to the requesting user (e.g., network administrator that requested the trace).

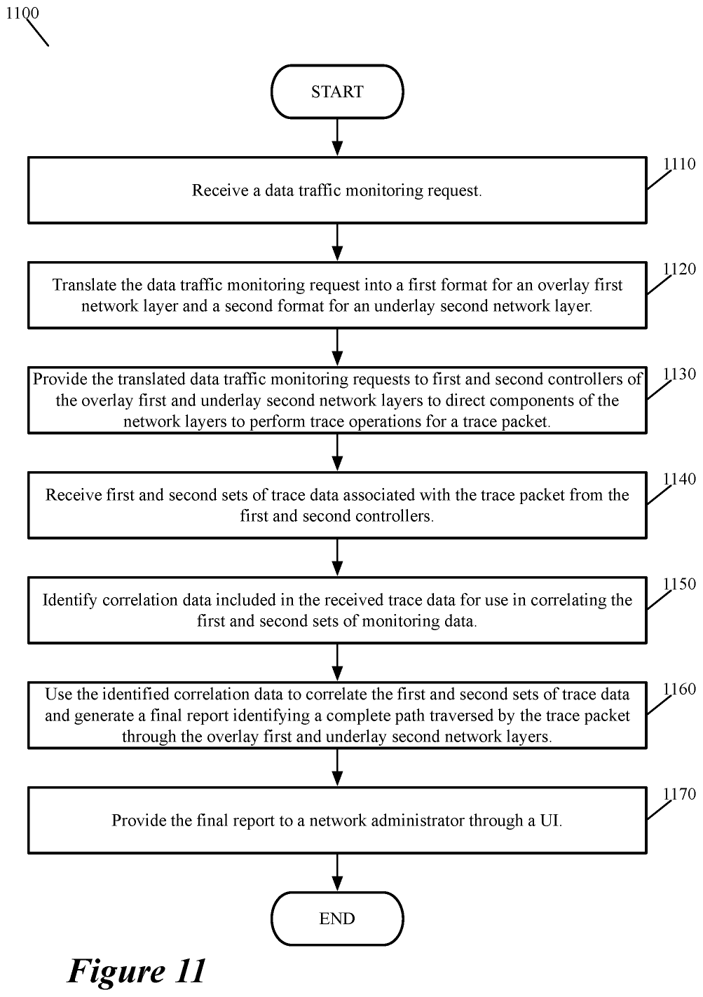

FIG. 11 conceptually illustrates a process of some embodiments for performing a packet trace in a system such as the systems illustrated in FIGS. 6, 7, 8, 9, and 10. The process 1100 is performed in some embodiments by the federation controller. The process 1100 starts when the federation controller receives (at 1110) a data traffic monitoring request.

The process 1100 translates (at 1120) the data traffic monitoring request into a first format for an overlay first network layer and a second format for an underlay second network layer, and provides (at 1130) the translated data traffic monitoring requests to first and second controllers of the overlay first and underlay second network layers to direct components of the network layers to perform trace operations for a trace packet. The network layers, in some embodiments, include a container network layer built on top of a logical network layer. The containers do not have awareness of the processes taking place within the VMs, or within the host computers, and vice versa, and as such, do not have awareness of any potential trace operations being performed by components of the different network layers. As such, each layer must be directed by their respective controller or controller cluster to perform the trace operation.

The process 1100 receives (at 1140) first and second sets of trace data associated with the trace packet from the first and second controllers. In some embodiments, each of the controllers for the network layers periodically aggregates trace results as the trace results are received, while in other embodiments, these controllers do not aggregate the trace results until the packet trace is completed (i.e., terminated). Similarly, the federation controller of some embodiments receives trace results from each of the network layer controllers periodically, while in other embodiments, the federation controller only receives complete sets of trace results from the network layer controllers. As such, in some embodiments, step 1140 is a recurring step until the packet trace is complete, while in other embodiments, step 1140 occurs once (or once for each controller of each network layer).

The process 1100 identifies (at 1150) correlation data included in the received trace data for use in correlating the first and second sets of monitoring data. In some embodiments, the correlation data is included with the each set of trace data received from a controller based on instructions included with the trace requests from the federation controller to the network layer controllers. The correlation data of some embodiments includes a marker identifying the trace data as trace data associated with the trace operations performed by each network layer. Also, in some embodiments, only one of the sets of trace data for the packet includes the correlation data, which is used to correlate all of the sets of trace data.

The process 1100 uses (at 1160) the identified correlation data to correlate the first and second sets of trace data and generate a final report identifying a complete path traversed by the trace packet through the overlay first and underlay second network layers. The complete path identified in the final trace report includes identifications of each component in the system traversed by the packet, according to some embodiments. The final trace report of some embodiments also includes other trace data collected by the components, such as metrics collected during any additional operations performed on the packet as part of the trace operations. The trace metrics and trace data of some embodiments includes packet latency, which can be used to identify underperforming components, under- or over-utilized resources, etc., according to some embodiments.

The process 1100 provides (at 1170) the final report to a network administrator through a UI. In some embodiments, the network administrator can analyze the final results to identify network issues, such as the issues described above that may be determined based on latency measurements included in the final results, or choke points between different network layers that may be causing network congestion or an increase of packet drops. Following 1170, the process 1100 ends.

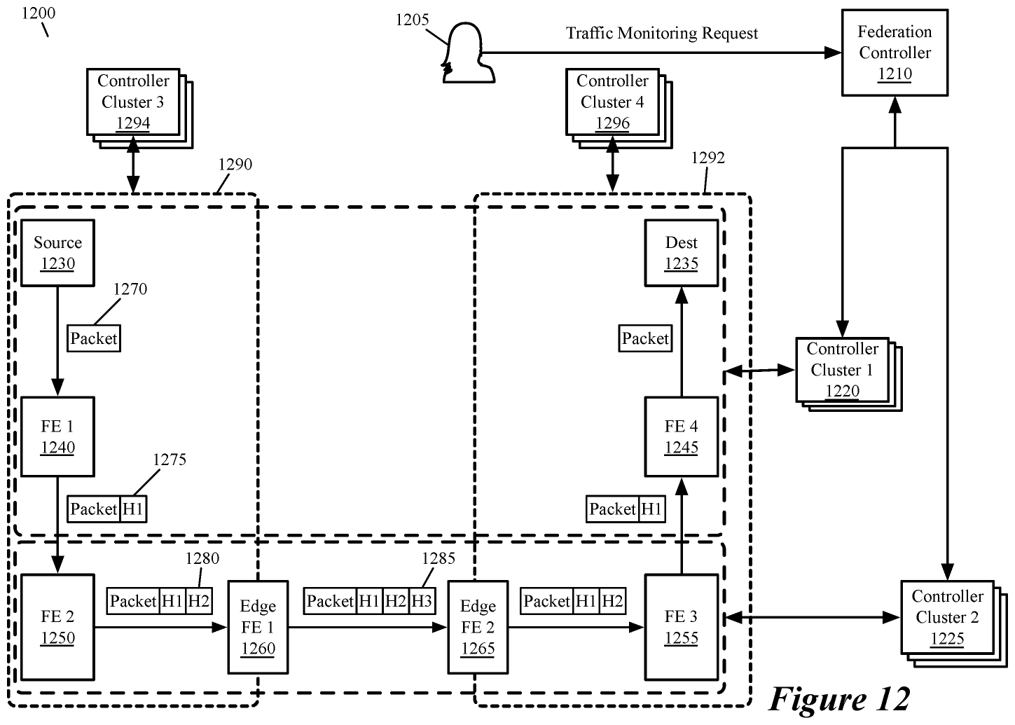

In some embodiments, a request may specify to perform a packet trace for a packet sent between a source in a datacenter and a destination in a public or private cloud datacenter that, e.g., provides a particular service. Such a trace packet would traverse one or more cloud gateways, and other forwarding elements in the intervening network fabric between the datacenter and service cloud, in some embodiments. FIG. 12 conceptually illustrates a path between such a source and destination, with two edge forwarding elements in the path of the trace packet. In some embodiments, different controllers manage the datacenter and service cloud, and a federation controller provides trace requests to each controller that manages a network element traversed by the trace packet. In some embodiments, one local controller may serve as a centralized controller that receives instructions from the federation controller, distributes the instructions to the other controllers, and collects trace results from the other controllers to provide to the federation controller.

The diagram 1200 includes a federation controller 1210, a controller cluster 1220 for a first network layer, and a controller cluster 1225 for a second network layer. In some embodiments, the first network layer is an overlay network layer that is managed by the controller cluster 1220 and includes sets of pods 1230 and 1235. The overlay network layer is built on top of a logical network that includes VMs 1240 and 1245. The logical network layer is built on top of a physical network layer that includes forwarding elements 1250 and 1255 as well as edge forwarding elements 1260 and 1265. The logical and physical network layers are managed by the controller cluster 1225 as shown. When the source and destination operate in separate datacenters/clouds, in some embodiments, each location includes its own respective controller clusters 1220 and 1225, which receive instructions from the respective clusters 1294 and 1296 that manage the datacenter 1290 and service cloud 1292.

In some embodiments, an intervening network fabric exists between the edge forwarding elements 1260 and 1265. In the example diagram 1200, the intervening network fabric includes wired or wireless connections, various network forwarding elements (e.g., switches, routers, etc.), etc. For instance, in some embodiments, a cloud gateway sits between the edge forwarding elements 1260 and 1265 and forwards packets, such as the trace packet 1270, to their next hops.

Upon receiving a traffic monitoring request from the network administrator 1205, the federation controller 1210 translates the request into formats compatible with the network layers managed by the controller clusters 1220 and 1225, and provides the requests to the controller clusters to direct the components of the system to perform the packet trace. In some embodiments, the federation controller instead distributes the request to one or both of the controller clusters 1294 and 1296, which translate the request and provide the request to controller clusters 1220 and 1225. The requests provided to the controller clusters 1220-1225 in some embodiments include a global trace identifier allocated by the federation controller for the traffic monitoring session. In other embodiments, rather than specifying a global trace identifier, the federation controller directs each of the controller clusters to allocate their own respective trace identifiers for use during the traffic monitoring session. Both approaches for using trace identifiers for the traffic monitoring session enable the forwarding elements traversed by the trace packet to efficiently filter the trace packet from other packets and perform operations (e.g., monitoring actions associated with the traffic monitoring session) on the trace packet, according to some embodiments.

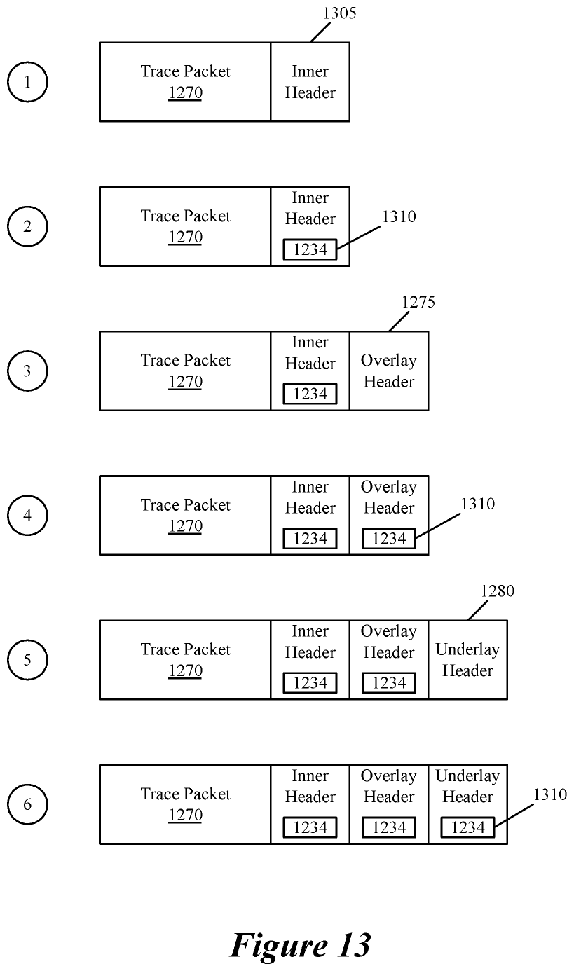

The request provided to the controller cluster 1220, in some embodiments, specifies to inject and trace a packet from the source 1230 to the destination 1235, using a particular global trace identifier (e.g., “1234”). The request provided to the controller cluster 1225, in some embodiments, specifies to trace a packet from the FE 1240 to the FE 1245, and also specifies the global trace identifier with additional instructions to only trace the overlay trace packet having the specified global trace identifier. Because the federation controller does not actually know the FEs 1240 and 1245 as they are in the overlay network, the federation controller specifies VMs, or logical ports related to the VMs, that host the FEs 1240 and 1245 and that are managed by the controller cluster 1225, according to some embodiments. FIG. 12 will be further described below with references to FIG. 13, which conceptually illustrates the trace packet 1270 in some embodiments as it is marked with a global packet identifier and encapsulated by the forwarding elements it traverses.

After the trace packet is injected to the source 1230, the source 1230 processes the packet 1270, and forwards the packet to the forwarding element 1240. In some embodiments, the source is a pod that forwards the packet to the forwarding element that operates on a VM on which the pod executes via a virtual interface of the forwarding element. The forwarding element 1240 then processes the packet 1270 by performing operations specified for the packet (e.g., applying security policies that match to the packet, performing load balancing, etc.), provides trace results (e.g., observations from the operations performed on the packet during processing) to the controller cluster 1220, marks an inner header of the packet with the trace identifier, and encapsulates the packet 1270 with a header 1275 (e.g., a Geneve header). The forwarding element 1240 also adds the trace identifier to the header 1275, and then forwards the encapsulated trace packet to the forwarding element 1250.

As illustrated by FIG. 13, the trace packet 1270 includes an inner header 1305 at the encircled 1. At the encircled 2, the inner header 1305 now includes a trace identifier 1310 added by the forwarding element 1240 described above. The trace packet 1270 is then encapsulated (at the encircled 3) with the overlay header 1275, which is then also marked (at the encircled 4) with the trace identifier 1310. The trace identifier 1310 on the inner header 1305 enables the forwarding elements of the underlay network to recognize the trace packet as a trace packet, while the trace identifier 1310 on the overlay header 1275 enables other forwarding elements of the overlay network to recognize the trace packet as a trace packet, as will be further discussed below.

Upon receiving the trace packet, the forwarding element 1250 recognizes the trace packet as a trace packet by checking the trace identifier in the packet's inner header. The forwarding element 1250 performs any applicable operations on the trace packet, reports its observations (e.g., trace results) to the controller cluster 1225, and encapsulates the trace packet again with an outer header 1280. In some embodiments, the outer header 1280 is a second Geneve header. The forwarding element then adds the trace identifier to the outer header 1280, and forwards the double encapsulated packet to the edge forwarding element 1260. For instance, at the encircled 5 in FIG. 13, the underlay header 1280 (i.e., outer header) has been added to the trace packet 1270. Finally, at the encircled 6, the underlay header 1280 is marked with the trace identifier 1310, which the forwarding element 1255 can subsequently use to recognize the trace packet as a trace packet upon receipt, as discussed below.

In some embodiments, the forwarding elements 1250 and 1255 are software forwarding elements (SFEs) that include logical ports and that perform packet-processing operations to forward packets received on one of their ports to another one of their ports. For example, in some embodiments, the SFE tries to use data in the packet (e.g., data in the packet header) to match the packet to flow-based rules, and upon finding a match, to perform the action specified by the matching rule (e.g., to hand the packet to one of its ports, which directs the packet to be supplied to a destination machine on the host or to a PNIC (physical network interface card) of the host).

After the forwarding element 1250 processes the packet 1270, the forwarding element 1250 encapsulates the packet with a second header 1280 and forwards the double-encapsulated packet (e.g., via a PNIC of the host computer) to the edge forwarding element (e.g., edge forwarding router) 1260 that sits at an edge between the datacenter 1290 and an intervening network between the datacenter 1290 and service cloud 1292. The edge forwarding element 1260 processes the packet 1270 (e.g., performs any actions specified for the trace operation, and additional operations configured as part of standard packet processing), and, in some embodiments, encapsulates the packet with a header 1285 in order to forward the packet across the intervening network to the edge forwarding element 1265.

In some embodiments, the packet traverses multiple managed and unmanaged forwarding elements across the intervening network. These managed and unmanaged forwarding elements, in some embodiments, include edge forwarding elements at the boundaries of various clouds traversed by the trace packet on its path to the destination. When the trace packet is finally received at the edge forwarding element 1265, the trace packet is decapsulated and the outer header 1285 used to forward the packet from the datacenter 1290 to the service cloud 1292 is removed. The edge forwarding element 1265 then performs any other processing of the packet specified for the trace operation, as well as any other standard processing operations configured for the edge forwarding element 1265, and forwards the processed trace packet 1270 to the forwarding element 1255.

The forwarding element 1255 recognizes that the packet 1270 is a trace packet based on the trace identifier added to the outer header 1280 by the forwarding element 1250. The forwarding element 1255 then decapsulates the packet and removes the outer header 1280, processes the packet as described above for the forwarding element 1250, and provides trace results (e.g., observations from the packet processing performed) to the controller cluster 1225. The forwarding element 1255 delivers the decapsulated packet to the forwarding element 1245.

Based on the trace identifier added to the header 1275 by the forwarding element 1240, the forwarding element 1245 recognizes the packet as a trace packet, and decapsulates the packet and removes the header 1275. The forwarding element 1245 then performs any packet processing operations applicable to the packet (e.g., for the trace, as well as any other standard operations), provides trace results to the controller cluster 1220, and delivers the decapsulated packet 1270 to the destination 1235. Like the forwarding element 1240, in some embodiments, the forwarding element 1245 is also a virtual switch (e.g., open virtual switch (OVS) bridge) implemented by a VM, and provides the packet to the destination 1235 via interfaces of the virtual switch. Once the destination 1235 receives the packet, the trace terminates, according to some embodiments.

The controller clusters 1220 and 1225 provide the trace results received from the components of the system to the federation controller 1210, in some embodiments, while in other embodiments, the results are provided to the controller clusters 1294 and 1296, which then provide the results from their respective locations to the federation controller 1210. In some embodiments, the trace results include correlation data for correlating and aggregating the trace results. The correlation data is specified by the federation controller 1210, in some embodiments, when providing the trace request to the controller clusters 1220 and 1225, such as by specifying a trace identifier for the monitoring session as discussed above. In other embodiments, the correlation data is determined by the controller clusters 1220 and 1225, such as each controller cluster allocating a respective trace identifier for marking the trace packet and marking trace results provided to the controller clusters.

The federation controller 1210 then uses the correlated and aggregated data to generate a report of the final results of the trace, and provides the report to the network administrator 1205 via a UI. In some embodiments, the final results include a mapping of the complete path traversed by the trace packet, as well as additional metrics collected during actions performed on the packet by the components of the system. In some embodiments, the final results enable the network administrator to identify points of congestion in the system that may be occurring between different network layers (e.g., between a pod and a VM).

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

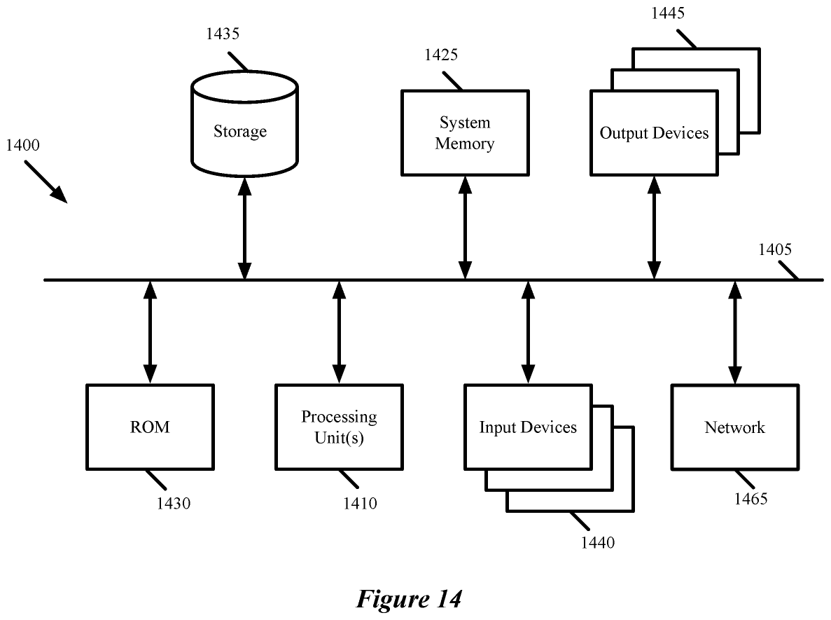

FIG. 14 conceptually illustrates a computer system 1400 with which some embodiments of the invention are implemented. The computer system 1400 can be used to implement any of the above-described hosts, controllers, gateway, and edge forwarding elements. As such, it can be used to execute any of the above described processes. This computer system 1400 includes various types of non-transitory machine-readable media and interfaces for various other types of machine-readable media. Computer system 1400 includes a bus 1405, processing unit(s) 1410, a system memory 1425, a read-only memory 1430, a permanent storage device 1435, input devices 1440, and output devices 1445.

The bus 1405 collectively represents all system, peripheral, and chipset buses that communicatively connect the numerous internal devices of the computer system 1400. For instance, the bus 1405 communicatively connects the processing unit(s) 1410 with the read-only memory 1430, the system memory 1425, and the permanent storage device 1435.

From these various memory units, the processing unit(s) 1410 retrieve instructions to execute and data to process in order to execute the processes of the invention. The processing unit(s) 1410 may be a single processor or a multi-core processor in different embodiments. The read-only-memory (ROM) 1430 stores static data and instructions that are needed by the processing unit(s) 1410 and other modules of the computer system 1400. The permanent storage device 1435, on the other hand, is a read-and-write memory device. This device 1435 is a non-volatile memory unit that stores instructions and data even when the computer system 1400 is off. Some embodiments of the invention use a mass-storage device (such as a magnetic or optical disk and its corresponding disk drive) as the permanent storage device 1435.

Other embodiments use a removable storage device (such as a floppy disk, flash drive, etc.) as the permanent storage device. Like the permanent storage device 1435, the system memory 1425 is a read-and-write memory device. However, unlike storage device 1435, the system memory 1425 is a volatile read-and-write memory, such as random access memory. The system memory 1425 stores some of the instructions and data that the processor needs at runtime. In some embodiments, the invention's processes are stored in the system memory 1425, the permanent storage device 1435, and/or the read-only memory 1430. From these various memory units, the processing unit(s) 1410 retrieve instructions to execute and data to process in order to execute the processes of some embodiments.

The bus 1405 also connects to the input and output devices 1440 and 1445. The input devices 1440 enable the user to communicate information and select commands to the computer system 1400. The input devices 1440 include alphanumeric keyboards and pointing devices (also called “cursor control devices”). The output devices 1445 display images generated by the computer system 1400. The output devices 1445 include printers and display devices, such as cathode ray tubes (CRT) or liquid crystal displays (LCD). Some embodiments include devices such as touchscreens that function as both input and output devices 1440 and 1445.

Finally, as shown in FIG. 14, bus 1405 also couples computer system 1400 to a network 1465 through a network adapter (not shown). In this manner, the computer 1400 can be a part of a network of computers (such as a local area network (“LAN”), a wide area network (“WAN”), or an Intranet), or a network of networks (such as the Internet). Any or all components of computer system 1400 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for performing data traffic monitoring for a system comprised of a set of heterogeneous networks, the method comprising:
at a federation controller for the system:
translating a request to perform data traffic monitoring into a first format for a first network platform in the set of heterogeneous networks and a second format for a second network platform in the set of heterogeneous networks;
providing (i) the data traffic monitoring request in the first format to a first controller for the first network platform and (ii) the data traffic monitoring request in the second format to a second controller for the second network platform;
collecting a plurality of data traffic monitoring results from the first and second controllers, the plurality of data traffic monitoring results received by the first and second controllers by a plurality of nodes belonging to the first and second network platforms through which a traceflow packet associated with the data traffic monitoring request passes; and
processing the collected plurality of data traffic monitoring results to generate a final data traffic monitoring result in response to the data traffic monitoring request.

2. The method of claim 1, wherein the collected plurality of data traffic monitoring results from the first and second controllers comprises a first plurality of data traffic monitoring results in the first format from the first controller and a second plurality of data traffic monitoring results in the second format from the second controller.

3. The method of claim 2, wherein processing the collected plurality of data traffic monitoring results to generate the final data traffic monitoring result comprises:
aggregating the collected first and second pluralities of data traffic monitoring results; and
translating the aggregated first and second pluralities of data traffic monitoring results into a single format to generate the final data traffic monitoring result.

4. The method of claim 1, wherein a source for the traceflow packet comprises a node belonging to the first network platform and the traceflow packet is injected into the source by the first controller.

5. The method of claim 4, wherein the first network platform comprises an SDN and the source comprises a logical port of a logical node.

6. The method of claim 1, wherein a source for the traceflow packet comprises a node belonging to the second network platform and the traceflow packet is injected into the source by the second controller.

7. The method of claim 6, wherein the second network platform comprises a CNI and the source comprises one of a container and a pod.

8. The method of claim 1, wherein:
the plurality of nodes comprises (i) a first set of nodes deployed in a first datacenter of the first network platform and (ii) a second set of nodes deployed in a second datacenter of the second network platform;
the first set of nodes comprises a first edge node deployed at an edge of the first datacenter;
the second set of nodes comprises a second edge node deployed at an edge of the second datacenter; and
upon receiving the traceflow packet at the second edge node from the first edge node, the second edge node (i) determines that the traceflow packet has the first format, (ii) translates the traceflow packet from the first format to the second format, and (iii) forwards the traceflow packet having the second format to a next hop in the second datacenter.

9. The method of claim 8, wherein:
the data traffic monitoring request is specified for a bidirectional flow; and
upon receiving the traceflow packet at the first edge node of the first datacenter from the second edge node of the second datacenter, the first edge node (i) determines that the traceflow packet has the second format, (ii) translates the traceflow packet from the second format to the first format, and (iii) forwards the traceflow packet having the first format to a next hop in the first datacenter.

10. The method of claim 1, wherein the data traffic monitoring request comprises a set of data traffic monitoring actions to be performed on the traceflow packet by the plurality of nodes belonging to the first and second network platforms through which the traceflow packet passes.

11. The method of claim 10, wherein the traceflow packet is encapsulated with a header specifying the set of data traffic monitoring actions prior to being injected into the system.

12. The method of claim 10, wherein the set of data traffic monitoring actions comprises at least two of packet tracing, packet capture, and packet count.

13. The method of claim 12, wherein the plurality of data traffic monitoring results comprises packet metrics associated with the set of data traffic monitoring actions performed on the traceflow packet.

14. The method of claim 10, wherein the data traffic monitoring request is specified for a bidirectional packet flow and the set of data traffic monitoring actions is performed on the traceflow packet in both directions of the bidirectional packet flow.

15. The method of claim 1, wherein the first network platform comprises an SDN (software-defined network) and the second network platform comprises a CNI (containerized networking interface).

16. The method of claim 1, wherein the data traffic monitoring request is received by the federation controller through a user interface from a system administrator for the system.

17. A non-transitory machine-readable medium storing a program which when executed by at least one processing unit performs data traffic monitoring for a system comprised of a set of heterogeneous networks, the program comprising sets of instructions for:
at a federation controller for the system:
translating a request to perform data traffic monitoring into a first format for a first network platform in the set of heterogeneous networks and a second format for a second network platform in the set of heterogeneous networks;
providing (i) the data traffic monitoring request in the first format to a first controller for the first network platform and (ii) the data traffic monitoring request in the second format to a second controller for the second network platform;
collecting a plurality of data traffic monitoring results from the first and second controllers, the plurality of data traffic monitoring results received by the first and second controllers by a plurality of nodes belonging to the first and second network platforms through which a traceflow packet associated with the data traffic monitoring request passes; and
processing the collected plurality of data traffic monitoring results to generate a final data traffic monitoring result in response to the data traffic monitoring request.

18. The non-transitory machine-readable medium of claim 17, wherein the collected plurality of data traffic monitoring results from the first and second controllers comprises a first plurality of data traffic monitoring results in the first format from the first controller and a second plurality of data traffic monitoring results in the second format from the second controller.

19. The non-transitory machine-readable medium of claim 18, wherein the set of instructions for processing the collected plurality of data traffic monitoring results to generate the final data traffic monitoring result comprises sets of instructions for:
aggregating the collected first and second pluralities of data traffic monitoring results; and
translating the aggregated first and second pluralities of data traffic monitoring results into a single format to generate the final data traffic monitoring result.

20. The non-transitory machine-readable medium of claim 17, wherein a source for the traceflow packet comprises a node belonging to the first network platform and the traceflow packet is injected into the source by the first controller.
